(19) United States
(12) Patent Application Publication
(10) Pub. No.: US 2010/0070549 A1
(43) Pub. Date: Mar. 18, 2010

(54) RANDOM NUMBER GENERATOR SYSTEM, METHOD FOR GENERATING RANDOM NUMBERS

(75) Inventor: Kiran Nagaraj, Bangalore (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/305,792

(22) PCT Filed: May 25, 2007
(86) PCT No.: PCT/IB2007/051976

§ 371 Date: Nov. 30, 2009

(30) Foreign Application Priority Data
Jun. 20, 2006 (EP) 06115696.4

(51) Int. Cl. G06F 7/58

(52) U.S. Cl. 708/254

(57) ABSTRACT

According to an exemplary embodiment a random number generator system, comprises a pre-processing unit, and a random number generation unit, wherein the pre-processing unit is adapted to calculate an internal seed out of an external seed and/or system variables and/or dynamic variables related to stack, and wherein the random number generation unit is adapted to generate a random number by using a determined function, wherein the determined function is a function of the internal seed and of at least one dynamic runtime variable related to the stack.

The invention relates to a random number generator system, a method for generating random numbers, a computer readable medium, and a program element, in particular to a method for generating a random number.

There exist many algorithms or methods to generate random numbers. Almost always, these algorithms are based on mathematical functions either directly or otherwise. Since Mathematics is an “Exact Science”, there is always an element of certainty. Therefore, these methods can also be called as “Pseudo” Random Number Generators.

Conventionally, the Random Number generating algorithms are constructed around a single or multiple mathematical functions. Typically, they make use of a so-called “seed”, which is to be initialized by the application. This seed is used in the function that computes the next random number. Since a mathematical function is used, the numbers that are generated by them form a well-defined sequence and the next random number can be predicted. Therefore, it is actually not a “random” number generation.

The following formula (extracted from one of the random number generation algorithm in a real-world application) exemplifies this:

random(xᵢ)=(xᵢ₋₁*31421)+6927, where 1≦i≦n, and x₀=0.

The above function generates the following sequence of numbers:

TABLE 1

| i [Number of invocation] | random(i) |
|---|---|
| 0 | 6927 |
| 1 | 31421 * random(0) + 6927 |
| 2 | 31421 * random(1) + 6927 |
| 3 | 31421 * random(2) + 6927 |
| . . . | . . . |

As can be seen in the above table the subsequent numbers can always be predicted. This predictability induces a sense of “pseudoness” in the method.

Also, there exist some other methods to generate random numbers, which accept the inputs from external sources like external hardware, application software etc.

For example, from U.S. Pat. No. 5,778,069 a random number generator is known, which includes an input device to assemble multiple classes of bits from multiple sources into an input bit string. The multiple classes of bits include an internal class of bits from at least one source internal to the random number generator, such as a static bit register, which maintains the current state of the generator. The input device also gathers one or more external classes of bits from one or more sources external to the random number generator, such as a machine class of bits, which relate to operating parameters of the computer and an application class of bits, which relate to execution of an application running on the computer. The input device concatenates the three classes of bits into an arbitrary length input bit string. The random number generator also has a hash computing device, which computes an m-bit hash value of the input bit string assembled by the input device. The hash computing device computes the hash value using a hashing function, such as SHA (secure hash algorithm), whereby it is computationally infeasible to derive the concatenated input bit string from the output hash value or intentionally bias the output of the hash function. The SE-IA is a one-way hash that reduces the 512-bit input bit string to a 160-bit hash value. The hash value becomes the initializing seed for the random number generator. A stream generator (i.e., a stream cipher) is coupled to the hash computing device to receive the hash value. The stream generator uses the hash value as the initializing seed to produce an output bit string of random (or pseudo random) bits.

Another method and system for generating pseudo-random numbers utilizing techniques of both the SHA-1 and DES encryption standards is known from WO2005/029315, wherein a pseudo-random number generator is re-keyed periodically using an external input of physical randomness. In accordance with one embodiment described therein, a current seed value Sj is loaded from a non-volatile storage. Next, values E, representative of environmental randomness, and Cm representative of configuration data are likewise loaded. A new seed value Sj+1, is generated in accordance with the equation Sj+1=f (Sj; A;C;E), wherein f represents a selected encryption algorithm, and B is a second constant, and wherein Sj is concatenated with A, which is concatenated with S which is concatenated with E. The new seed is then written to the non-volatile storage. Next, a key, K, is generated in accordance with the equation K=f(Sj; B; C; E), wherein B is a second constant. Lastly, a pseudo-random number putout, Pn, is generated in accordance with equation Pn=f3DES(K, Pn−1) where f3DES represents the operation of triple DES encryption hardware, and Pn−1 is the previously generated pseudo-random number.

It may be desirable to provide a random number generator system, a method for generating random numbers, a computer readable medium, and a program element, which may generate random numbers in an efficient way without any dependency on any kind of external hardware specific for this purpose alone.

This desire may be met by a random number generator system, a method for generating random numbers, a computer readable medium, and a program element according to the independent claims.

According to an exemplary embodiment a random number generator system comprises a pre-processing unit and a random number generation unit, wherein the pre-processing unit is adapted to calculate an internal seed out of an external seed and/or system variables and/or dynamic variables, and wherein the random number generation unit is adapted to generate a random number by using a determined function, wherein the determined function is a function of the internal seed and of at least one dynamic runtime variable related to the stack.

According to an exemplary embodiment a method for generating a random number by a random number generation system is provided, the method comprises inputting an external seed, generating an internal seed by using the external seed and/or system variables and/or dynamic variables, and generating a random number by using a predetermined function which is a function of the internal seed and at least one dynamic runtime variable relating to the stack.

According to an exemplary embodiment a computer readable medium is provided in which a program for generating a random number is stored, which program, when executed by a processor, is adapted to control a method comprising inputting an external seed and/or system variables and/or dynamic variables, generating an internal seed by using the external seed, and generating a random number by using a predetermined function which is a function of the internal seed and at least one dynamic runtime variable relating to the stack.

According to an exemplary embodiment a program element for generating a random number is stored, which program, when executed by a processor, is adapted to control a method comprising inputting an external seed, generating an internal seed by using the external seed and/or system variables and/or dynamic variables, and generating a random number by using a predetermined function which is a function of the internal seed and at least one dynamic runtime variable relating to the stack.

It may be seen as the gist of an exemplary embodiment of the present invention that a new, simple and comprehensible method to implement a random number generator may be provided, different from their conventional counterparts, in the sense that it may not make use of a mathematical function to generate random numbers. Instead, it exploits on the dynamic elements (or the run time environment) of a system i.e. uses the contents of the stack of an executing process/task/thread as input parameters for generating random numbers, since the stack is one of the most dynamic (as it grows and shrinks) entities of the operating environment, in which this algorithm executes, thereby making the random number generation more unpredictable and hence more “random”. That is, according to an exemplary embodiment, it might be exploited that the execution environment of an application itself provides many dynamic parameters that easily qualify to be better candidates as inputs for the random number generation algorithm. One of the most indispensable entities of the execution environment is the stack. The processor implicitly assumes the existence of a stack while execution. Because of the multi-tasking abstraction provided by the operating system, it provides a separate stack for each process/task (in case of a multi-threaded application, each thread has its own stack). Each process/task uses its stack for its execution. During execution of a program, the stack grows and shrinks with every function call and return, respectively. Therefore, the contents of the stack are ever changing.

Compared to the method according to U.S. Pat. No. 5,778,069 a fundamental difference might be that according to U.S. Pat. No. 5,778,069 for a given input initial seed, the random number generation sequence will remain the same, in order to facilitate the decryption of the encrypted text, since U.S. Pat. No. 5,778,069 belongs towards cryptographic applications. However, according to the above mentioned exemplary embodiment of the present invention, different random numbers are generated irrespective of the external (initial) input seed value, the place of invocation of the method, or consecutive invocations.

The term “function” has to be understood in a broad sense and not limited to a mathematical function. It might as well be that the initial seed, which might represent a string of bits, is formed into the number, which corresponds to this string of bits so that no further calculation or mathematical operation is necessary.

In the following, further exemplary embodiments of the random number generator system will be described. However, these embodiments apply also for the method for generating random numbers, the computer readable medium and the program element.

According to another exemplary embodiment of the random number generator system the at least one dynamic runtime variable relates to one out of the group consisting of: return address, program counter, stack pointer, un-initialized local variables, architecture-specific register values stored on the stack.

All such dynamic runtime variables are more “unreliable” parameters. Thus, it is looked beyond the usage of a mathematical function, in order for the algorithm to generate a more “random” value. However, additionally a mathematical function may be also combined with these parameters to possibly make the random number generator system more effective. The predetermined (executing) function may use only a part of the stack called the “Stack Frame”. The stack frame of the executing function is called the ‘Active Stack Frame’. Typically, the contents of the stack frame may be the return address, some architecture dependant registers, local variables etc. Each function, when invoked, may create its own stack frame and may revert the same when it returns. By virtue of the very nature of processor execution, the stack space may be shared between one or more function, which is at the same level of invocation.

The local variables in the stack frame may be used by that function alone. It may not be mandatory to initialise these variables. If the local variable is not initialised, then it may contain the value that existed on the stack as initialised by the previously invoked functions. Together with the number of functions that the process/task may invoke (maybe within the same program or external library), it may be almost impossible to predict the contents of the stack.

Also, the return address on the stack may vary when the function is invoked from various places in the process/task. Therefore, it may also be difficult to predict what the return address would be from within a given function. The parameters such as the return address and un-initialised local variables may therefore be used as input parameters for the random number generation algorithms, because, “unpredictability” itself is an essential characteristic of a random number generator.

According to one aspect, the random number generation system is adapted to use an algorithm, which uses the return address and the un-initialised local variables as their inputs. Along with these, there may be an external seed value supplied by the caller, an internal seed value and the invocation counter.

According to another exemplary embodiment the random number generator system further comprises a post-processing unit, wherein the post-processing unit is adapted to post process the random number.

The post-processing unit operates upon the generated random number and, if necessary, operates upon the random number to generate a more random value. The output of this post-processing unit is the final random number output by the system. For example, the post-processing unit may be adapted to perform bit manipulation of the generated random number to output a random number that contains almost the same numbers of 1s and 0s. Or perform some other bit manipulations such as XOR, NAND, and NOR operations and the like.

According to another exemplary embodiment of the random number generator system the random number generator system is adapted to calculate the internal seed out of the external seed and a system variable when calculating a first random number. Preferably, this calculation of an internal seed by using the external seed is only done when the random number generator is invoked the first time, i.e. to calculate the first random number of a consecutive row of random numbers. Preferably, the system variable is one out of the group consisting of Process ID, Task ID, Thread ID, Return Address, Un-initialised local variable, present time, time stamp and system time.

According to another exemplary embodiment of the random number generator system the random number generator system is adapted to use the first random number as the internal seed for the generation of a second random number, and possible subsequent random numbers. Preferably, the second random number is a consecutive random number of the first random number, i.e. the next generated random number.

By using a first random number as the internal seed for the calculation of the next random number it may be possible to provide a sequence of random numbers which is much more random than the sequences of pseudo-random numbers which are generated by a system according to the prior art. Thus, a sequence of random numbers may be generated wherein for the generation of a next random number always the directly or indirectly, e.g. by manipulating the bits of the random number and then copying, foregoing random number is used as the internal seed.

In the following, further exemplary embodiments of the method for generating random numbers will be described. However, these embodiments apply also for the random number generator system, the computer readable medium and the program element.

According to another exemplary embodiment of the method the at least one dynamic runtime variable relates to one out of the group consisting of: return address, program counter, stack pointer, un-initialized local variables, architecture-specific register values stored on the stack.

According to another exemplary embodiment of the method the predetermined function comprises the selecting of some bits from the internal seed and of some bits of the at least one dynamic runtime variable. Alternatively, the predetermined function comprises the concatenating of all bits from the internal seed and of the at least one dynamic runtime variable. Further, alternatively predetermined function comprises the mixing of all bits from the internal seed and of all bits of the at least one dynamic runtime variable.

All the above mentioned methods may be efficient ways to generate a random number, which is highly random out of the different input parameters.

According to another exemplary embodiment of the method the predetermined function is a DES encryption algorithm or a Hash-algorithm, e.g. the SHA-1 algorithm or alike.

According to another exemplary embodiment the method further comprises up-dating the internal seed by using the first generated random number. Preferably, the method further comprises up-dating a local un-initialized variable by using the generated random number.

Both of these measures may ensure that a random number generated after the first random number, i.e. a consecutive random number, may be more random in relation to the first random number, i.e. the sequence of random numbers generated in such a way may be more random than a sequence of random numbers generated according to a method according to the prior art.

According to another exemplary embodiment the method further comprises post-processing the generated random number by using bit manipulations. Preferably, the bit manipulating is at least one out of the group consisting of substantially equalizing a number of 1 and 0 in the generated random number, XOR, NAND, and NOR.

According to another exemplary embodiment of the method the at least one dynamic runtime variable related to a currently active stack or a and/or valid stack frames of the calling function(s) that lie below the currently active stack frame and/r unused stack space that lie above the currently active stack frame.

According to another exemplary embodiment of the method the return address is de-referenced to obtain operation code, and the obtained operation code is used as one of the dynamic runtime variables related to stack.

According to another exemplary embodiment the method further comprises reading a value in any valid memory location, wherein the value is used as one of the dynamic runtime variables related to stack. The memory may either be a statically or dynamically allocated memory.

According to another exemplary embodiment of the method in the pre-processing step at least one of the dynamic runtime variables related to stack is used; and/or in the generation step at least one of the system variables is used.

It may be seen as a gist of an exemplary embodiment that a random number generation method is provided, wherein a random number generator is not built around a mathematical function to generate the random number. Instead, it makes use of runtime environment of the generator program (thread or task or process, for example). This phenomenon may be a key feature of this algorithm. This concept may induce an element of uncertainty, owing to the dynamic characteristics of the runtime environment, to the method of generating the random numbers. Such an “uncertainty” itself is an essential characteristic of a random number generator. At any given point in time, the runtime environment of a process/task may be represented by the Program Counter (PC), the Stack Pointer (SP), register contents and the stack contents, and return address. Also these parameters are really “dynamic” (as their values are ever changing). These parameters, therefore, may qualify as choices to represent the run time environment. Also, other dynamic elements such as system timers or any other variable available in the environment may also be employed in particular for the generation of the internal seed from an external seed.

Contrary thereto, the method, described in U.S. Pat. No. 5,778,069, is mainly targeted towards Cryptographic Applications. Whereas the present application is not targeted to any particular application. U.S. Pat. No. 5,778,069 also mentions that for a given input initial seed, the random number generation sequence will remain same (to facilitate the decryption of the encrypted text). However, the present application is intended to generate different random numbers irrespective of the initial input seed value, or the place of invocation of the function, or consecutive invocations et cetera. Apparently, The method described in U.S. Pat. No. 5,778,069 is intended for PC (or related desktop/server) type computers, since certain parameters that are listed under the machine class of bits are applicable only in the PC environment. In contrast, the teaching of the present application can be applied also in embedded environments. In the method described in U.S. Pat. No. 5,778,069 the application class of bits is to be supplied by the application using this method. Therefore, the method described in U.S. Pat. No. 5,778,069 is partly dependent on the client to provide an input bit string. In case the application provides an input bit string consisting of say all zeros or all ones the overall randomness of the input bit string would be reduced. In contrast, according to the present invention although the external seed is supplied by the client, it is not the only input parameter that is used to calculate the Internal Seed and consequently the random number itself.

WO 2005/029315 discloses a hardware implementation of the method to generate pseudo-random numbers. In particular, this method requires special hardware like triple-DES encryption hardware, external (or on-chip) non-volatile memory, protected ROM to store constants. In contrast, the present application does not pose any such constraint. The method of WO 2005/029315 poses certain severely limiting physical constraints that are assumed—the potential adversaries must not have unsupervised access to this equipment, especially the off-chip non-volatile memory to be kept secure from unauthorized access. Further it is assumed that the attacker does not have unsupervised access to the electrical interface. All of these constraints are not imposed in a method according to the present invention.

According to one exemplary aspect of this invention, the random number generation makes use of the above-mentioned dynamic parameters of the operating environment. The process itself may be categorized into multiple stages: pre-processing, generation, and post-processing (optional). It must be noted that this classification, is only for the purpose of understanding and does not form the essence of this application.

The pre-processing step may accept an external seed and other runtime variables like a time stamp and uses them to generate an internal seed. The generation step may use the internal seed and dynamic runtime variables relating to the stack content as input to generate a random number. The post-processing step may operate upon the generated random number and, if necessary, operates upon the random number to generate a more random value. This step is optional. The output of this step may be the final random number output by the system.

Random numbers are used widely by various applications on a variety of platforms. These application might include, on the ubiquitous PC platform, the development of various game programs that involve some sort of random selection like card games etc., generating random play lists on the PC based media players, for generating names some temporarily used objects. That is, 1. generating names for temporary files that are by product of a bigger process for example, a C compiler generates a temporary intermediate file after every stage of compilation, and 2. performing name mangling for certain symbols during compilation et cetera. Random number generation functions are also part and parcel of the standard programming libraries (like libc etc.). Further, application might include making “dynamic and ever changing” web pages involving rich applets, generating session identifiers in web browsers; computer modelling and simulations et cetera. Further applications might be on play/gaming stations/kiosks in casinos that require some sort of random selection, and/or on other embedded platforms, like the DVD Players/DVD Recorders, the random number generation function to generate shuffled play lists of media files (MP3 files, Chapters in a DVD Title etc.). It can also be of use on mobile phone platforms considering the amount of variety and complexity that is getting into these devices. Or to various other devices. In recent years the proliferation of security-related applications has increased the need for good random numbers for example the automatic password generation programs, keys used in SSL/TLS-enabled web browsers, or random challenges in Kerberos. In cryptographic applications, the random number generators are employed to generate the key values (public/private) or the initial seed values or the message digest. Therefore, the variety of its applications makes this idea more “fundamental” and the scope of its impact is broad.

These and other aspects of the present invention will become apparent from and elucidated with reference to the embodiment described hereinafter. It should be noted that all aspects and embodiments described anywhere in this application may be mixed and/or combined with each other.

An exemplary embodiment of the present invention will be described in the following, with reference to the following drawings.

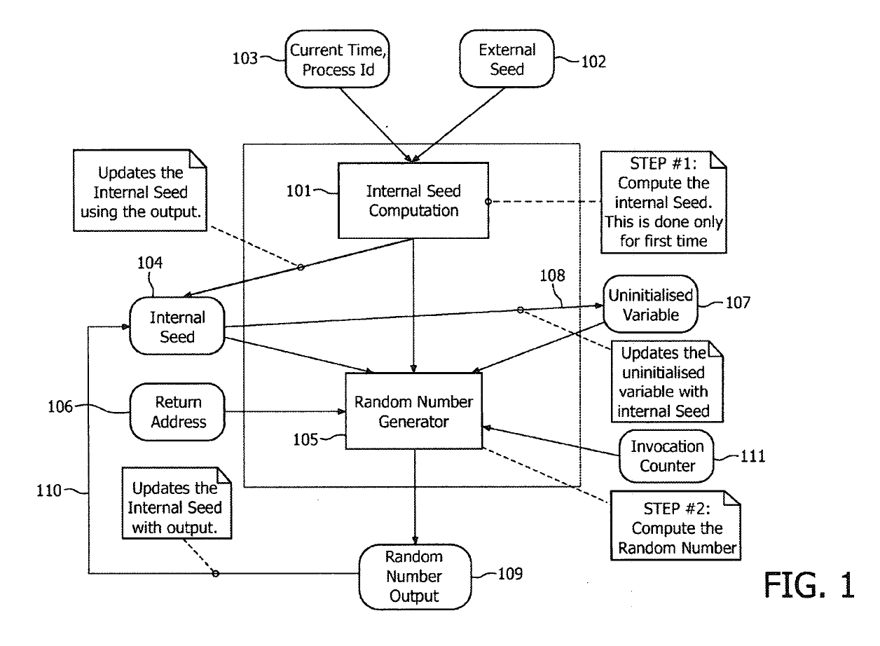

FIG. 1 shows a simplified schematic flowchart of a method for generating random numbers according to an exemplary embodiment.

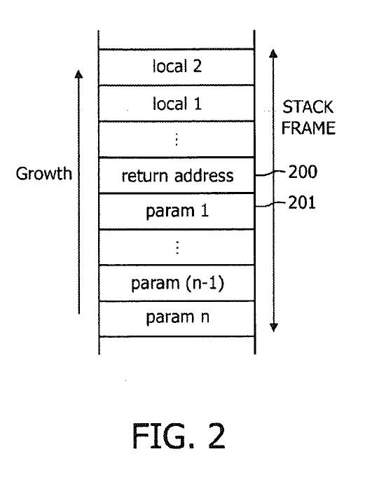

FIG. 2 shows a simplified schematic stack frame.

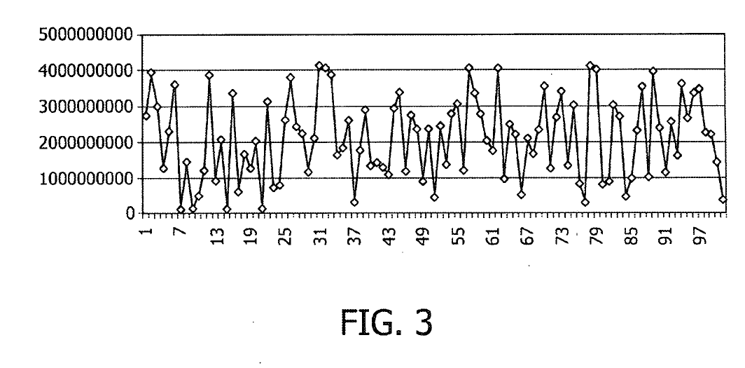

FIG. 3 shows a schematically diagram of a sequence of random numbers generated by a method according to an exemplary embodiment.

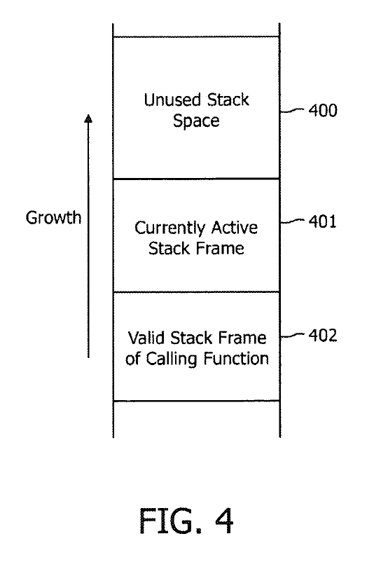

FIG. 4 shows a schematically organization of multiple stack frames.

The illustration in the drawings is schematically. In different drawings, similar or identical elements are provided with the similar or identical reference signs.

In the following an exemplary embodiment of a random number generation is described in more detail. The proposed random number generation method makes use of stack based runtime parameters (like return address, stack contents, seed value, un-initialized local variables) as input to generate the random number. This process can be categorized into multiple steps: pre-processing (or internal seed computation), generation, and post-processing (optional).

The internal seed computation 101 accepts the various stack based runtime input parameters like external seed 102, current time and/or process ID/Task ID103, and the like and uses them to generate the internal seed. The internal seed computation 101 involves selecting some bits from each of the input parameters and combining them in such a way that the output internal seed 104 is as random as possible. The order of selection of bits, and/or their positions from various input parameters can vary with each invocation of the random number generator to make the output much more unpredictable. The present embodiment may not mandate the way in which the input parameters are combined. Therefore, it may be up to the implementation to perform an optimal combination that yields the best possible output value. Alternatively, the internal seed computation can also involve concatenation of the input parameters to obtain a longer input value, provided the computing environment and platform supports.

The first part, the internal seed computation, is executed only once when the random number function is invoked for the first time (i.e., when an invocation count is zero). The purpose of this step is to compute a value to the internal seed. The internal seed is a persistent local variable that is used as an input for the second part to a generate random number. The external seed, the current process/task id (and also thread id, in case of a multi-threaded application), and the current time are hashed to obtain the internal seed. The hash algorithm can be a one-way function that reduces larger input bit string to a smaller bit string (For example, a diluted variant of a SHA-1 algorithm is used that converts a 128 bit input string to a 32 bit output string). Alternatively, the initialization of the internal seed can also be implemented as part of a different function altogether, which shall be called prior to the actual random number generation algorithm.

In the second step, the actual random number is computed 105. The internal seed 104, the return address 106, the un-initialized local variable 107 and the invocation counter 111 are hashed to generate a random number. The invocation counter is incremented every time the function is invoked. The un-initialized variable 107 is then initialized with the value of the internal seed, indicated by the arrow 108. And the internal seed is updated with the value of the random number computed 109, so that the value is retained for subsequent invocations to compute new random numbers. This updating is indicated in FIG. 1 by the arrow 110. It is evident that the randomness can be improved by using more un-initialized local variables the higher the number, the better the randomness.

In some rare scenarios, it might be possible that the random number generation algorithm is invoked from the same place within a loop, in which case the return address on the stack remains same. Therefore, the return address alone may not suffice. Also, the contents of the stack are likely to remain same. This scenario appears to an ultimate test case. Therefore, to retain uniqueness, it is required that the at least one of the input parameters should vary. Under such circumstances, the invocation counter (static variable) and the internal seed (static variable) serve the purpose. Also, some compilers generate code such that the local stack variables are implicitly initialized to a default value when the stack frame is made. In some other scenarios, especially on PCs, the consecutive execution of the same program might yield similar results. Therefore, to ensure the randomness of the random number series, it is required to have a unique internal seed computation. Therefore, the Process/task Id (and/or Thread Id), and/or the current time are used to compute the internal seed. The random number generation algorithm, if implemented as a shared library (or a DLL) can yield better results, as the same function is shared across different processes/threads.

Having discussed about the dynamic stack contents like the return address, un-initialized local variables etc, the description of the stack layout is in order. Most platforms (processor architecture/operating environment) use the following stack layout, which is schematically shown in FIG. 2. Also, by default, the compilers generate code for the same layout. The stack can be viewed as consisting a number of stack frames, cach frame representing a function. The frame that represents the currently executing function is called the “Active Stack Frame”.

The post-processing step is optional and operates upon the generated random number and, if necessary, operates upon the random number to generate a more random value. This step is optional. The output of this step is the final random number output by the system. Typically, it may be used to perform bit manipulation of the generated random value to output a random number that contains of almost even number of 1s and 0s. Or perform some other bit manipulations such as XOR, NAND, and NOR operations et cetera.

As already mentioned, most platforms (processor architecture/operating environment) use the following stack layout, which is schematically shown in FIG. 2. Also, by default, the compilers generate code for the same layout, unless instructed otherwise. The stack can be viewed as consisting a number of stack frames, each frame representing a function. A typical stack frame is depicted in FIG. 2.

As indicated in the FIG. 2, the return address 200 is stored on the stack just above the first argument to the function 201. The parameters are stored in reverse order on the stack. Therefore, the return address can be retrieved by using a pointer, and pointing it to the location above the first parameter, and de-referencing the pointer. The stack frame of each function is stored one above the other, such that the called function's stack frame is above the calling function's stack frame (see FIG. 4). Therefore, all the stack frames that lie below the current frame are valid and therefore can be used to retrieve the values randomly. These values can be used as input parameters to the random number generation too. But the memory that lies above the current stack frame cannot be accessed as it is not known whether it is valid (see FIG. 4). Perhaps on PC it can be accessed too, as the invalid memory access results in a page fault, which the Operating System handles gracefully, by loading the requested page into the address space of the process/task.

However, it is imperative that the contents of these stack memory remains unaltered. Therefore, these memory locations on the stack is only read and not modified. As an enhancement, the following could also be implemented. The return address of a function indicates the address from where the execution would resume when this function returns. Since the return address varies depending upon the place of invocation, it follows that the instruction to be executed next can also be different. Therefore, the corresponding instruction operation-code (opcode) can also be used as input parameter to generate the random number. This opcode can be retrieved by de-referencing the return address.

As another enhancement to this embodiment, it is interesting to note that randomness can also be extracted from dynamic memory allocations. It is possible to allocate a varying size of memory. Depending upon the size (and the algorithm internally followed by the memory manager), the starting address of the allocated memory might vary. This can also be a candidate for input parameters to calculate the random number. The contents of the allocated memory can also be random (but some standard libraries initialize them with default data).

It is evident that the return address alone might not guarantee a “true randomness”. Therefore, other parameters that vary contiguously (either autonomously or otherwise) may also be involved in the computation. For example, the time is one of the parameter that is varying (autonomously) with every invocation. The time value can be queried from the system timers, real time clock, or time stamp counters etc. Also, maintaining an un-initialized stack variable is also possible. Since the stack grows and shrinks during the execution of the program, the value of the un-initialized stack variable keeps changing with various functions overwriting the value. However, in such cases as illustrated in FIG. 2, the value could remain same. This is why the value of the un-initialized variable is updated, (after it is used) with the Internal Seed after the generation step.

In the following a so-called pseudo code of an exemplary embodiment of the method is described.

| GetRandomNumber(ExternalSeed) | |
|---|---|
| { | |
| /* Retrieve the return address */ | |
| /* This is as per the stack layout defined in the Fig.2. | |
| It is specific to architecture. */ | |
| pRA = ADDRESSOF(ExternalSeed); | |
| pRA = pRA −1; | |
| /* STEP #1: Internal Seed Computation */ | |
| IF NrInvocations = 0 THEN | |
| /* Get the current process id and time */ | |
| Pid = getpid( ); | |
| Time = time( ); | |
| InternalSeed = Hash(ExternalSeed, Pid, Time); | |
| ENDIF | |
| /* Increment the invocation counter */ | |
| NrInvocations = NrInvocations + 1; | |
| /* STEP #2: Random Number Generation */ | |
| RandomNumber = | Hash(InternalSeed, |
| | ReturnAddress, |
| | Uninitialised, |
| | NrInvocations); |

```
    /* Update the Internal Seed and Uninitialised value */
    Uninitialised = InternalSeed;
    InternalSeed = RandomNumber;
    return RandomNumber;
}
```

The RandomFunction( ) routine is the actual function that computes the next random number. It is interesting to note that there can be many implementations possible for the RandomFunction( ) routine. Therefore, it offers a flexibility to choose an optimal random number generator function depending upon the requirement.

The Hash( ) routine is any one-way hash algorithm like SHA family of algorithms. It follows that the randomness of the implementation can be improved by using a better hash function—the better the hash function, better the randomness. Again, it is not the only implementation that is possible. The implementation can be improved by using better hash algorithms and hashing multiple times.

As an exemplary embodiment this method was implemented and executed on MS Windows (Visual Studio Compiler) and Linux (gcc compiler) platforms both running on Intel 32-bit Pentium architecture. One of the possible implementation along with the test data and results are provided here to illustrate the concept. This is a very restrictive implementation of the proposed algorithm. This is because, the enclosed implementation, the random number is generated in a loop, which implies that the return address does remain constant. The randomness can be improved by a real life application which calls random number generator from various locations/context. On a 64-bit machine this can yield better randomness.

This implementation was tested on an Intel Pentium based 32-bit machine on both Linux and Windows platforms. The random number generator algorithm generates a 32 bit random number. The results of this test are shown in FIG. 3. The random number generator was invoked N [=101] number of times. The random number generated is sampled and the line graph depicting the variations is generated.

FIG. 3 depicts a range of 2̂32 bits (equivalent to an interval 0-4294967295). Each dot represent one generated random number having a value between 0 and 4294967295. It can be noticed that between two consecutive random numbers the sufficient variation exist and hence the zig-zag curve. Also, the generated random numbers are uniformly spread across such a huge range of values.

FIG. 4 shows a schematically organization of multiple stack frames. Such a multiple stack frame comprises several parts. In the middle of FIG. 4 a part is shown which relates to the currently active stack frame 401. In FIG. 4 above this currently active stack frame 401 the unused stack space 400 is depicted, while below the currently active stack frame 401 the part of the stack frame is shown which represents the stack frame valid for calling function 402.

In the following the random numbers generated by this exemplary embodiment were tested by the ENT tool, which is available on the web and which performs a variety of tests on the random sequence. These tests include the Entropy Test, Arithmetic Mean, Monte-Carlo method etc. Using the above implementation, a large number of random numbers was generated [N=10,000,001]. This output was given to the ENT tool. Also, the same number of random values were generated using the standard library rand( ) function, i.e. a standard random number generator, the output of which was also given to ENT tool. The following table summarizes the result.

TABLE 2

| | | | | | Serial |
|---|---|---|---|---|---|
| | Plat- | Entropy | Arithmetic | Monte Carlo | Correlation |
| Algorithm | form | Value | Mean | Value of π | Coefficient |
| Libc Rand | Win- | 4.888541 | 47.6553 | 3.957735041 | −0.055975 |
| (Prior art) | dows | | | | |
| | Linux | 7.954201 | 111.4619 | 3.487414256 | −0.049344 |
| RNGA | Win- | 7.997735 | 127.0570 | 3.147828348 | 0.010313 |
| (present | dows | | | | |
| invention) | Linux | 7.999964 | 127.4688 | 3.143122428 | 0.000059 |
| Expected | | Greater | 127.5 | 3.139648438 | Nearer to 0 |
| Value | | the value, | | | |
| (Ideal | | More | | | |
| Case) | | random is | | | |
| | | the | | | |
| | | sequence. | | | |

From the output of the performed ENT-Test, which is given in table 2, it can be verified that the proposed method yields a better randomness.

For a further testing of the random number generator according to an exemplary embodiment, a test of the National Institute of Standards and Technology was used. The National Institute of Standards and Technology has defined a set of test cases for which to test the randomness of sequence. It defines tests like Frequency Test, Block Frequency Test, Universal Test, Limpel-Ziv compression algorithm etc. A large number of random values were generated [N=10,000,001] using both the proposed method and the standard library rand( ) function. These outputs were provided to the NIST test suite program that generates a P-Value for each test case for each sequence. According to the user manual of the test suite, if the P-Value of the random sequence is >0.01, then the sequence is considered random. The following table 3 summarizes the result.

TABLE 3

| | Libc Rand | | RNGA | | |
|---|---|---|---|---|---|
| | (P-Value) | | (P-Value) | | |
| Test | Linux | Windows | Linux | Windows | Remarks |
| Frequency | 0.00000 | 0.00000 | 0.350485 | 0.73992 | |
| Block | 0.53415 | 0.00000 | 0.911413 | 0.53415 | m = 32 |
| Frequency | | | | | |
| Cumulative | 0.00000 | 0.00000 | 0.534146 | 0.91141 | |
| Sum- | | | | | |
| Forward | | | | | |
| Cumulative | 0.00000 | 0.00000 | 0.739918 | 0.53415 | |
| Sum- | | | | | |
| Backward | | | | | |
| Runs | 0.00000 | 0.00000 | 0.534146 | 0.0043 | |
| Longest | 0.00000 | 0.00000 | 0.213309 | 0.00888 | |
| Runs Of | | | | | |
| Ones | | | | | |
| Rank | 0.00000 | 0.00000 | 0.739918 | 0.99147 | |
| FFT | 0.00000 | 0.00000 | 0.017912 | 0.73992 | |
| Universal | 0.35049 | 0.00000 | 0.739918 | 0.12233 | L = 10, Q = |
| | | | | | 10240 |
| Approximate | 0.00000 | 0.00000 | 0.350485 | 0.73992 | m = 12 |
| Entropy | | | | | |
| Serial | 0.00000 | 0.00000 | 0.739918 | 0.73992 | m = 12 |
| Lempel-Ziv | 0.12233 | 0.00000 | 0.534146 | 0.91141 | |

From the above table 3, it can be seen that the proposed method has better P-Values. For more information concerning the above-mentioned test it is referred to the URL of the National Institute of Standards and Technology http://csrc.nist.gov/rng/rng2.html.

Summarizing, the fundamental intent of the present application may be not to suggest an implementation (of function), but rather to propose an idea that can be implemented in multiple ways.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

In the following as an annex an exemplary implementation of a program code implementing an exemplary embodiment of a random number generator is given as a source code of a C-program. This specific source code is given just for illustrative purpose and the present invention is not limited to this specific implementation.

```
/***********************************************************
*
* RANDOM NUMBER GENERATION ALGORITHM
*
* This program is an illustration of the Random Number Generation
* Algorithm that is based on the using the contents of the stack.
*
* During run time the stack grows and shrinks with each function
* invocation, respectively. Each function uses the stack as a
* storage for temporary variables. Apart from the local variables,
* the return address, some architecture specific register values,
* function arguments etc. Therefore, these parameters can be
* used to generate random numbers.
*
* Generally, unless the values of the local variables are
* initialised within the function, they hold unknown or spurious
* values left behind on the stack by the previous function.
* Also, since the function can be called from many different
* places in the program, the return address can vary with every
* invocation.
*
* The following program illustrates one of the possible
* implementation of this concept. This is by no means the only
* method to generate the random numbers using this concept.
* The implementation can be improved by using a better hash
* algorithm and with a number of local uninitialised values.
* In the following program, the random random numbers are
* generated in a loop and the values are printed.
* It was executed on a Linux platform running on Intel X86
* Architecture and on Windows platform on Intel X86 Architecture.
************************************************************/
/***********************************************************
* Include Files
***********************************************************/
#include <stdio.h>
#include <stdlib.h>
#include <string.h>
#ifdef WIN32
#include <process.h>
#else
#include <syscall.h>
#endif
#include <time.h>
#include <sys/timeb.h>
/***********************************************************
* Data Type Definitions
***********************************************************/
typedef unsigned char Byte;
typedef unsigned long int UInt32;
typedef signed long int Int32;
/***********************************************************
* Constant values
***********************************************************/
const Byte C0 = 0x67;
const Byte C1 = 0xEF;
const Byte C2 = 0x10;
const Byte C3 = 0x98;
/***********************************************************
* Prototypes.
***********************************************************/
/*
* SimpleHash:
* This function implements the reduced/diluted version of the
* SHA-1 algorithm. It accepts an input string of string 128 bits
* (16 bytes) and converts it into an output bit string of 32 bits
* (4 bytes = size of an integer on PC). It acts as a one-way hash
* conversion function that produces almost unique values for
* similar input bit strings.
*/
void SimpleHash(UInt32 NrBits, Byte InStr[16], Byte OutStr[4]);
/*
* GetRandomNumber:
* This function generates the random numbers.
* It accepts an external seed and returns a random number.
* Along with the external seed, it uses the return address, the
* uninitialised local variables, the internal seed, the
* invocation counter etc to generate the random number.
*/
UInt32 GetRandomNumber(UInt32 ExternalSeed);
void ConvertBinary2Ascii(UInt32 Number, char Str[33]);
int main( )
{
  UInt32 Out = 0;
  int i;
  char Number[33];
  /*
  * Generate 10,00,001 random numbers in a loop.
  * Print them.
  */
  for (i = 0; i < 1000001; i++)
  {
    /*
    * This is one of the worst case scenarios for this
    * algorithm because the return address for the
    * GetRandomNumber( ) function always remains same.
    * Hence, one of the variables remains constant.
    * Another reason is that the stack space used by the
    * GetRandomNumber( ) function is shared with printf( )
    * function too. Hence, the uninitialised local variables
    * might have predictable values too.
    */
#if defined PURPOSE_VIEW
    printf(“RN#[%3d]:\t%u\n”, i, GetRandomNumber(Out));
#elif defined PURPOSE_TEST_BINARY
    Out = GetRandomNumber(Out);
    fwrite((void *) &Out, 4, 1, stdout);
    Out = 0;
#elif defined PURPOSE_TEST_ASCII
    memset(Number, 0, 33);
    Out = GetRandomNumber(Out);
    ConvertBinary2Ascii(Out, Number);
    fwrite((void *) Number, 32, 1, stdout);
    Out = 0;
#endif
  }
  return 0;
}
/*
* GetRandomNumber:
* This function generates the random numbers.
* It accepts an external seed and returns a random number.
* Along with the external seed, it uses the return address, the
* uninitialised local variables, the internal seed, the
* invocation counter etc to generate the random number.
*/
UInt32 GetRandomNumber(UInt32 ExternalSeed)
{
  /*
  * InternalSeed: One of the input values for the computation of
  * the random number generation algorithm. It is persistent and
  * is constantly updated with every invocation.
  */
static UInt32 InternalSeed;
  /*
  * NrInvocations: One of the input values for the computation of
  * the random number generation algorithm. It is persistent and
  * is incremented with every invocation. This ensures that the
  * atleast one of the input parameters does vary with every
  * invocation. This is requried when the more dynamic parameters
  * like the return address etc are constant as in the case of
  * this program.
  */
static UInt32 NrInvocations;
  /*
  * Uninitialised: One of the input values for the computation of
  * the random number generation algorithm. It is a temporary
  * variables that is created when the function is invoked (the
  * stack frame is created) and destroyed when the function
  * returns (stack frame unwinds). This local variable is used
  * without initialising with any value, so that the value is
  * as unpredictable (random) as possible.
  * The more the number of such uninitialised local variables,
  * the better the randomness. However, here we use only one.
  * It is also the case that some compilers do generate code
  * for each function, that initialises these local variables
  * implicitly with some default value when the stack frame is
  * created. But this can be ignored as long as one of the input
  * parameters are different.
  */
  UInt32 Uninitialised;
  /*
  * RandomNumber: The value that will be returned to the caller.
  */
  UInt32 RandomNumber;
  /*
  * pRA: Pointer to the Return Address on the stack.
  * The contents of this pointer i.e., *pRA is the actual
  * return address.
  */
  UInt32 *pRA;
  /*
  * Input: The input bit string 128 bits long.
  */
  Byte Input[16];
  /*
  * Out: Holds the output value of the hash function.
  */
  UInt32 Out;
  /*
  * Pid: Holds the current process identifier.
  */
  Int32 Pid;
  /*
  * cur_time: The current time structure.
  */
  struct timeb cur_time;
  /*
  * Retrieve the return address from the stack.
  * On a standard stack layout the return address is stored
  * on the stack after the parameters are pushed in the reverse
  * order. Therefore, the return address is stored above the
  * first parameter.
  */
  /*
  * Get the address of the first parameter
  * and decrement the same to point to the return address on
  * the stack. On a PC, the stack grows towards lesser addresses.
  */
  pRA = (UInt32 *) &ExternalSeed;
  pRA−−;
  /*
  * Since some compilers, do initialise the stack variables
  * implicitly with some default value and also if no other
  * program is executing currently, then successive execution
  * of this program might result in same output. Therefore,
  * we can use the ProcessId (and also ThreadId in case of
  * multiple threaded applications) and/or also the current
  * time, at the point when the program is started, to compute
  * the initial value of the Internal Seed, for the first time.
  * This problem should not occur when this function is
  * implemented as a separate dynamic link library
  * or shared library that is shared across multiple processes.
  */
  if (NrInvocations == 0u)
  {
    Pid = getpid( );
    ftime(&cur_time);
    //printf(“Pid: %d\n”, Pid);
    //printf(“Millisecond: %u\n”, cur_time.millitm);
    /*
    * Compute the internal seed by hashing the External Seed,
    * ProcessId and the Millisecond part of the current time,
    * as this varies faster than the hour, minute, second etc.
    */
    memset(Input, 0, 16);
    memcpy(&Input[0], (Byte *) &ExternalSeed, 4);
    memcpy(&Input[4], (Byte *) &Pid, 4);
    memcpy(&Input[8], (Byte *) &cur_time.millitm, 4);
    SimpleHash(64, Input, (Byte *) &Out);
    InternalSeed = Out;
  }
  /*
  * Increment the Invocation counter.
  */
  NrInvocations++;
  /*
  * Computer the actual random number.
  * It is the hash value of InternalSeed, Return Address,
  * Uninitialised local value and the Invocation counter.
  */
memset(Input, 0, 16);
  memcpy(&Input[0], (Byte *) &InternalSeed, 4);
  memcpy(&Input[4], (Byte *) pRA, 4);
  memcpy(&Input[8], (Byte *) &Uninitialised, 4);
  memcpy(&Input[12], (Byte *) &NrInvocations, 4);
  SimpleHash(128, Input, (Byte *) &Out);
  RandomNumber = Out;
  /*
  * Update the uninitialised value.
  */
  Uninitialised = InternalSeed;
  /*
  * Update the persistent internal seed value with the
  * generated random number, so that the next invocation
  * there is more randomness.
  */
  InternalSeed = RandomNumber;
  return RandomNumber;
}
/*
* SimpleHash:
* This function implements the reduced / diluted version of the
* SHA-1 algorithm. It accepts an input string of string 128 bits
* (16 bytes) and converts it into an output bit string of 32 bits
* (4 bytes = size of an integer on PC). It acts as a one-way hash
* conversion function that produces almost unique values for
* similar input bit strings.
* This algorithm is similar to that of SHA-1 algorithm.
*/
void SimpleHash(UInt32 NrBits, Byte InStr[16], Byte OutStr[4])
{
  Byte ProcStr[64];
  Byte InputStr[16];
  int i;
  Byte Temp, k, g;
  UInt32 n;
  memset(InputStr, 0, 16);
  memcpy(InputStr, InStr, NrBits / 8);
  /*
  * Input string size is byte aligned or not.
  */
  n = NrBits % 8;
  /*
  * In case the number of bits is < 96, then
  * concatenate the input bit string with
  * a ‘1’ followed by ‘0’s until the last 32 bits.
  * In the last 32 bits, store the length of the string.
  */
if (NrBits <= 95)
{
  /*
  * Input string size is not byte aligned.
  */
  if (n != 0)
  {
    InputStr[(NrBits / 8)] |= (1 << n);
  }
  else
  {
    InputStr[(NrBits / 8)] |= 1;
  }
  /*
  * Append the size of string in the last 32 bits.$$
  */
  *((UInt32 *) (InputStr + 12)) = NrBits;
}
/*
* Copy the input string into a process string.
*/
memset(ProcStr, 0, 64);
memcpy(ProcStr, InputStr, 16);
for (i = 16; i < 64; i++)
{
  ProcStr[i] =
  (ProcStr[i−3]\hat{ }ProcStr[i−7]\hat{ }ProcStr[i−12]\hat{ }ProcStr[i−16]) << 1;
}
OutStr[0] = C0;
OutStr[1] = C1;
OutStr[2] = C2;
OutStr[3] = C3;
for (i = 0; i < 64; i++)
{
  if ((i >= 0) && (i < 16))
    {
      g = (OutStr[1] & OutStr[2]) | (~OutStr[1] & OutStr[3]);
      k = 0x5A;
    }
    else if ((i >= 16) && (i < 32))
    {
    g = (OutStr[1] \hat{ } OutStr[2] \hat{ }OutStr[3]);
    k = 0x6E;
    }
    else if ((i >= 32) && (i < 48))
    {
      g = (OutStr[1] & OutStr[2]) | \
          (OutStr[3] & OutStr[2]) | \
          (OutStr[1] & OutStr[3]);
      k = 0x8F;
    }
    else
    {
      g = (OutStr[1] \hat{ } OutStr[2] \hat{ } OutStr[3]);
      k = 0xCA;
    }
    Temp = (OutStr[0] << 2) + g + k + OutStr[3] + ProcStr[i];
    OutStr[3] = (OutStr[2] >> 2) | (OutStr[3] << 6);
    OutStr[2] = (OutStr[1] << 3) | (OutStr[1] >> 5);
    OutStr[1] = OutStr[0];
    OutStr[0] = Temp;
  }
}
void ConvertBinary2Ascii(UInt32 Number, char Str[33])
{
  Int32 i;
  Str[32] = ‘\0’;
  for (i = 31; i >= 0; i−−)
  {
    Str[31 − i] = (Number & (1 << i)) ? ‘1’ : ‘0’;
  }
}
```

1. Random number generator system, comprising:
a pre-processing unit; and
a random number generation unit;
wherein the pre-processing unit is adapted to calculate an internal seed out of at least one of: an external seed, system variable, and dynamic variables related to the stack; and
wherein the random number generation unit is adapted to generate a random number by using a determined function, wherein the determined function is a function of the internal seed and of at least one dynamic runtime variable related to the stack.

2. The random number generator system according claim 1,
wherein at least one dynamic runtime variable related to stack is one out of the group consisting of:
return address;
program counter;
stack pointer;
un-initialized local variables; and
architecture-specific register values stored on stack.

3. The random number generator system according to claim 1, further comprising:
a post-processing unit,
wherein the post-processing unit is adapted to post process the random number.

4. The random number generator system according to claim 1,
wherein, when calculating a first random number the at least one system variable is one out of the group consisting of:
system time;
Process ID;
Task ID, and
Thread ID.

5. The random number generator system according to claim 4, wherein the random number generator system is adapted to use the first random number as the internal seed for the generation of a second random number either directly or indirectly.

6. Method for generating a random number by a random number generation system, the method comprising:
inputting an external seed;
generating an internal seed by using at least one of the external seed, a system variable, and a dynamic variable related to stack; and
generating a random number by using a predetermined function which is a function of the internal seed and at least one dynamic runtime variable relating to the stack.

7. The method according to claim 6,
wherein the at least one dynamic runtime variable related to the stack one out of the group consisting of:
return address;
program counter;
stack pointer;
un-initialized local variables; and
architecture-specific register values stored on stack.

8. The method according to claim 6,
wherein, when calculating a first random number the at least one system variable is one out of the group consisting of:
system time;
Process ID;
Task ID, and
Thread ID.

9. The method according to claim 6,
wherein the predetermined function comprises selecting some bits from the internal seed and of some bits of the at least one dynamic runtime variable.

10. The method according to claim 6,
wherein the predetermined function comprises concatenating of all bits from the internal seed and of the at least one dynamic runtime variable.

11. The method according to claim 6,
wherein the predetermined function comprises mixing of all bits from the internal seed and of all bits of the at least one dynamic runtime variable.

12. The method according to claim 6,
wherein the predetermined function is a DES encryption algorithm or a Hash-algorithm, in particular SHA-1.

13. The method according to claim 6, further comprising:
up-dating the internal seed by using a first generated random number directly or indirectly.

14. The method according to claim 6, further comprising:
post-processing the generated random number by using bit manipulations.

15. The method according to claim 14,
wherein the bit manipulating is at least one out of the group consisting of:
substantially equalizing a number of 1 and 0 in the generated random number;
XOR;
NAND; and
NOR.

16. The method according to claim 6,
wherein the at least one dynamic runtime variable related to a currently active stack or an and/or valid stack frames of the calling function(s) that lie below the currently active stack frame and/r unused stack space that lie above the currently active stack frame.

17. The method according to claim 6,
wherein the return address is de-referenced to obtain operation code, and
wherein the obtained operation code is used as one of the dynamic runtime variables related to stack.

18. The method according to claim 6, further comprising:
reading a value in any valid memory location,
wherein the value is used as one of the dynamic runtime variables related to stack.

19. The method according to claim 6,
wherein in the pre-processing step at least one of the dynamic runtime variables related to stack is used; and/or
wherein in the generation step at least one of the system variables is used.

20. A computer readable medium in which a program for generating a random number is stored, which program, when executed by a processor, is adapted to control a method comprising:
inputting an external seed;
generating an internal seed by using at least one of the external seed, a system variable, and a dynamic variable related to stack; and
generating a random number by using a predetermined function which is a function of the internal seed and at least one dynamic runtime variable relating to the stack.

21. (canceled)
